(19) United States
(12) Patent Application Publication
(10) Pub. No.: US 2019/0026701 A1
(43) Pub. Date: Jan. 24, 2019

(54) MATCHING JOB POSTINGS TO JOB SEEKERS

(71) Applicant: ADP, LLC, Roseland, NJ (US)

(72) Inventors: Jens Audenaert, New York, NY (US); Marina Mijatovic, Los Angeles, CA (US)

(21) Appl. No.: 15/654,832

(22) Filed: Jul. 20, 2017

(51) Int. Cl. G06Q 10/10; G06Q 10/06

(52) U.S. Cl. CPC G06Q 10/1053; G06Q 10/10; G06Q 10/06

(57) ABSTRACT

A computer-implemented method, system and computer program product for matching job seekers to job postings are provided. The computer-implemented method, system and computer program product provide a board in which job seekers and employers may post messages. The messages from the employers may include employer profiles, job postings etc. The employers may use a set of structured words in submitting the messages. The messages from the job seekers include the job seekers' profiles. The job seekers may use the same set of structured words used by the employers to generate and submit their profiles. Accordingly, the computer-implemented method, system and computer program product use the structured words in the job postings and/or employer profile and the job seekers' profiles to match job seekers to job postings.

### BACKGROUND

### 1. Field

The present disclosure relates to job searches, and more particularly, to a computer-implemented method, system and computer program product for matching job seekers to job postings.

### 2. Description of the Related Art

In recent years, more and more companies have been using ethnographic research to gain a full understanding not only of their customers, but also of their own business. Ethnography is a research method that entails embedding oneself deeply and over a long time in a field site of study in order to systemically document the everyday lives, behaviors, and interactions of a community of people. The goal of an ethnographer is to develop a rich understanding of how and why people think, behave, and interact as they do in a given community or organization from the standpoint of those who are being studied.

Companies that help employers find, hire and manage talent, are also using ethnographic research to better understand today's workforce. According to an ethnographic research, most workers stumble into jobs. This leads one to believe that existing job boards (e.g., Indeed, Monster etc.) or career social platforms (e.g., LinkedIn etc.) are ineffective at matching job seekers with existing job posts. This, then, leads to wasted time on behalf of job seekers and recruiters or employers, and major global losses in productivity since workers are not in the best fit jobs and thus are not reaching their full potential.

Therefore, there is a need for a system and method that overcome these shortcomings.

### SUMMARY

In the present invention, an improvement over current methods of matching job seekers to job postings is provided. Specifically, the invention enables only users (i.e., recruiters/companies) that are serious about recruiting new talent to make use of a job posting board. Likewise, only users, such as job seekers, who are serious about obtaining a new job will frequent the board (i.e., no social interactions). Since the board is not a social board, job seekers may be less reluctant to use the board.

Further and according to an embodiment of the invention, all submissions from job seekers will be verified. This is to ensure the veracity of the information submitted by the job seeker. Hence, recruiters and companies will no longer have doubts about the veracity of information in a person's resume or profile since the submitted profile will be verified.

In addition, according to another embodiment of the invention, both the recruiters or companies and job seekers are required to use the same structured data (i.e., structured words) to make their submission. This allows for a more accurate algorithm to be used in matching job seekers to job postings.

Accordingly, the present disclosure provides a computer-implemented method, system and computer program product for matching job seekers to job postings. The computer-implemented method, system, and computer program product provide a board in which job seekers and employers may post messages. The messages from the employers may include job postings while the messages from the job seekers may include a profile. The computer-implemented method, system, and computer program product define a set of structured words to be used by both the job seekers and the employers in posting the messages, and match the job seekers to the job postings using the defined set of structured words.

In a particular embodiment, the profile submitted by the job seeker includes a verified employment history. The employment history is verified through a background search. Further, the profile may include a psychometric test and/or an assessment test.

In another embodiment, the computer-implemented method, system and computer program product allow the job seeker to submit an update to the verified profile. The update may also be verified.

In yet another embodiment, the job postings include one of required skills, experiences and compensations. The job postings may further include a description of a culture fostered by the employers, the fostered culture being used to determine whether a fit exists between a job seeker and the employer.

### BRIEF DESCRIPTION OF THE DRAWINGS

FIG. 1 is a pictorial representation of a network of data processing systems in which the present invention may be implemented;

FIG. 2 is a block diagram of a data processing system that may be implemented as a server, which, in a preferred embodiment of the present disclosure, may be used to help employers find, hire and manage talent in accordance with an illustrative embodiment;

FIG. 3 is a block diagram illustrating a data processing system in which the present disclosure may be implemented;

FIG. 4 is an illustration of a flowchart of a process that may be used by a job seeker to submit a profile onto a job matching board in accordance with an illustrative embodiment;

FIG. 5 is an illustration of a flowchart of a process that may be used by a job matching company to ensure that profiles are verified in accordance with an illustrative embodiment;

FIG. 6 is an illustration of a flowchart of a process that may be used by an employer to submit job postings onto the job matching board in accordance with an illustrative embodiment;

FIG. 7 is an illustration of a flowchart of a process that may be used by a job matching company to match job seekers to job postings in accordance with an illustrative embodiment;

FIG. 8 is an illustration of a block diagram of a data processing system in accordance with an illustrative embodiment; and

FIG. 9 is an illustration of a list of structured words or data that may be displayed to a user in accordance with an illustrative embodiment.

### DETAILED DESCRIPTION

The present invention is directed to effectively matching job seekers to job postings. To do so, the present invention requires job seekers to give access to their verified employment history and employers (i.e., recruiters and hiring companies etc.) to provide (non-public and non-exposed) information on job postings. In accordance with an embodiment of the invention, both job seekers and employers need to use structured data around skills, experience, compensation, and desired geographical locations, etc. to allow for better matching of job seekers to job postings. In addition, psychometric and/or career assessment tests may be used to further enrich job seekers' profiles. Job postings, on the other hand, can be further enriched with certain qualities to further refine search algorithms and allow for additional qualities such as, for example, a work culture fit. Job seekers, in this case, will always be in charge of which data is exposed to employers at any point in time. The data may be used in aggregate and may not be governed by client contracts.

In one particular aspect, the present invention may allow a job matching company to disrupt and grow its presence in the background check industry, and become much more efficient in the recruitment process outsourcing (RPO) business. The present invention may also allow a much better human resources (HR) on-boarding process by letting job seekers expose all required information for certain on-boarding processes, all leading to a competitive benefit to the job matching company in its core businesses.

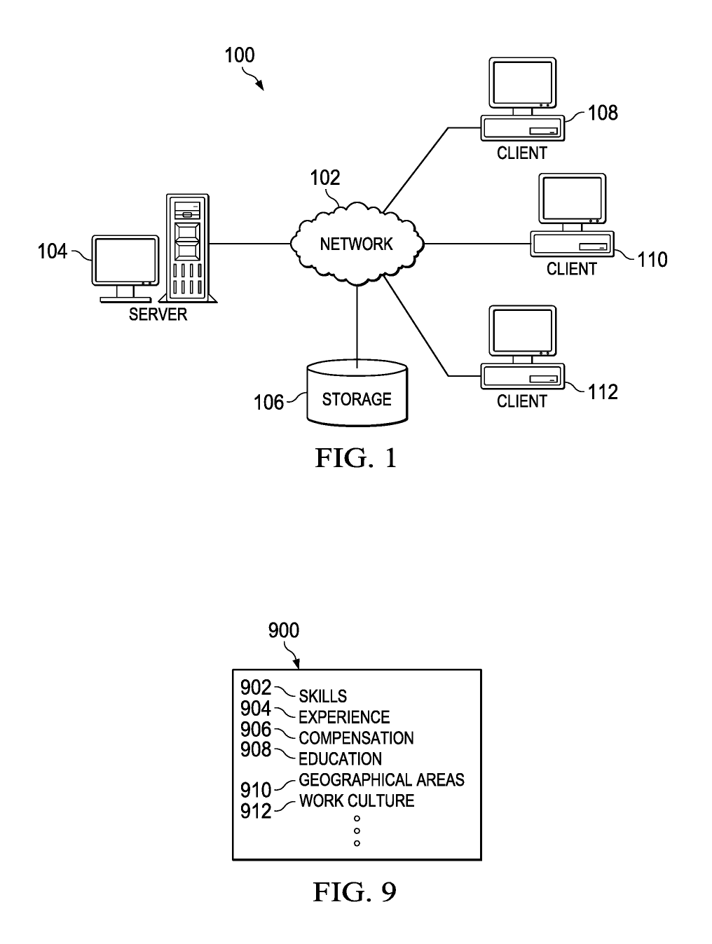

With reference now to the figures, FIG. 1 depicts a pictorial representation of a network of data processing systems in which the present invention may be implemented. Network data processing system 100 is a network of computers that contains network 102, which is the medium used to provide communications links between various devices and computers connected together within network data processing system 100. Network 102 may include connections, such as wire, wireless communication links, fiber optic cables etc.

In the depicted example, server 104 is connected to network 102, along with storage unit 106. In addition, clients 108, 110, and 112 are connected to network 102. Clients 108, 110, and 112 may be, for example, personal computers or network computers. In the depicted example, server 104 may provide data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the present invention.

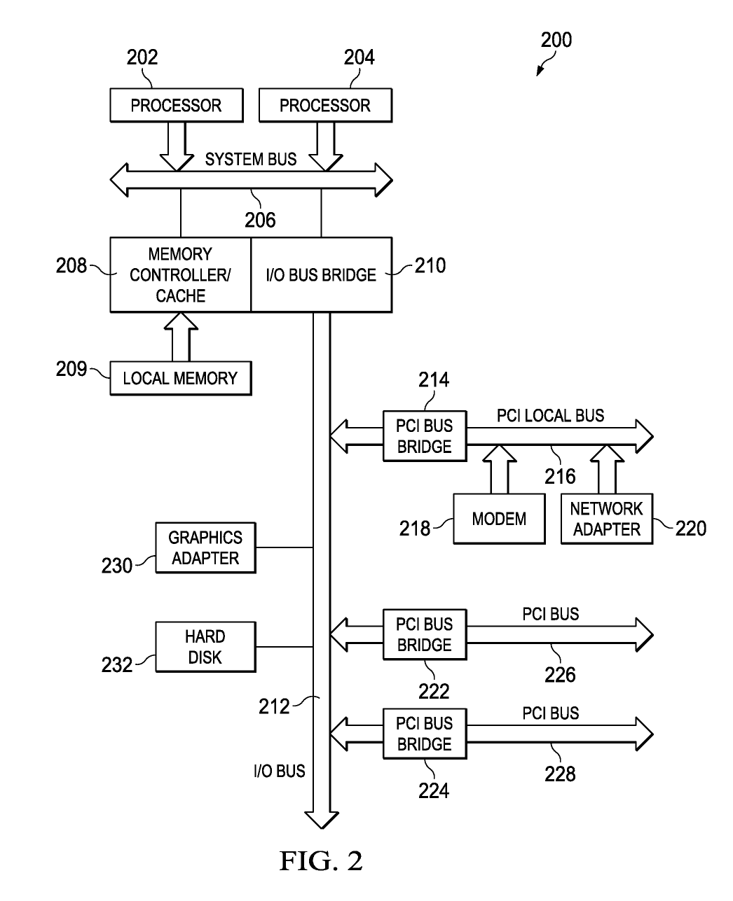

Referring to FIG. 2, a block diagram of a data processing system that may be implemented as a server, which in a preferred embodiment of the present disclosure may be used to help employers find, hire and manage talent depicted in accordance with an illustrative embodiment. Data processing system 200 may be a symmetric multiprocessor (SMP) system including a plurality of processors, including processor 202 and processor 204 connected to system bus 206. Alternatively, more than one or a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214, connected to I/O bus 212, provides an interface to PCI local bus 216. A number of modems may be connected to PCI local bus 216. Typical PCI bus implementations will support four PCI expansion slots or add-in connectors. Communications links to server 104, shown in FIG. 1, or to other computer systems (not shown) in FIG. 1 may be provided through modem 218 and network adapter 220 connected to PCI local bus 216 through add-in boards.

Additional PCI bus bridges, such as PCI bus bridge 222 and PCI bus bridge 224, provide interfaces for additional PCI local bus 226 and PCI local bus 228, from which additional modems or network adapters may be supported. In this manner, data processing system 200 allows for connections to multiple computer systems. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives, universal serial bus (USB) drives and the like, also may be used, in addition to or in place of, the hardware depicted. Thus, the depicted example is not meant to imply architectural limitations.

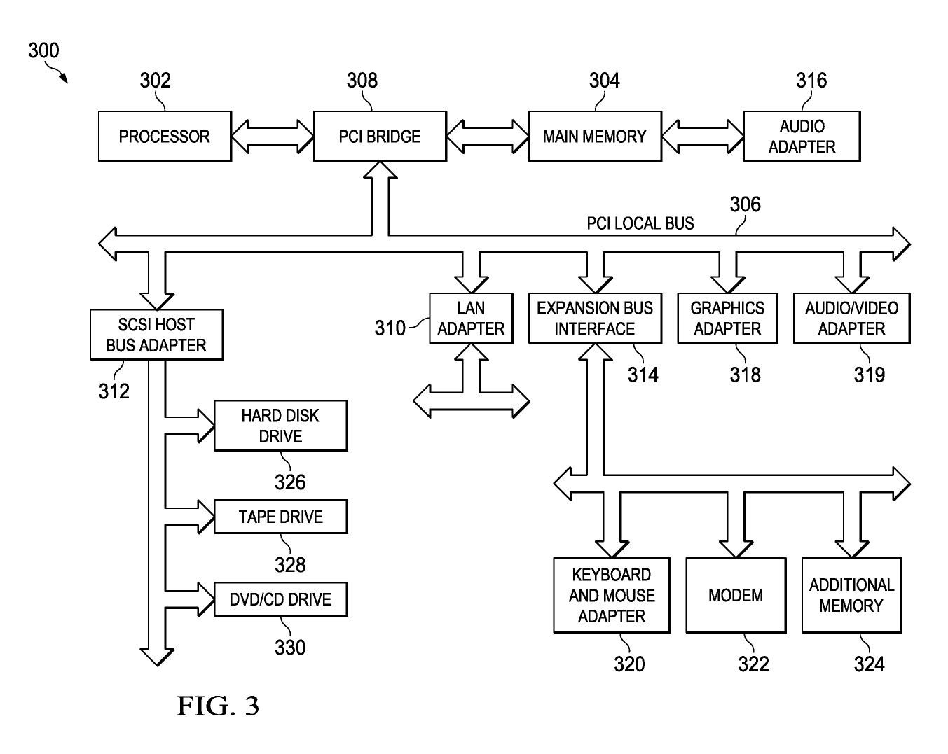

With reference now to FIG. 3, a block diagram illustrating a data processing system is depicted in which the present disclosure may be implemented. Data processing system 300 is an example of a client computer, such as server 104 of FIG. 1. Data processing system 300 employs a peripheral component interconnect (PCI) local bus architecture. Although the depicted example employs a PCI bus, other bus architectures such as accelerated graphics port (AGP) and industry standard architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by a direct component connection. In contrast, audio adapter 316, graphics adapter 318, and audio/video adapter 319 are connected to PCI local bus 306 by add-in boards inserted into expansion slots. Expansion bus interface 314 provides a connection for keyboard and mouse adapter 320, modem 322, and additional memory 324. Small computer system interface (SCSI) host bus adapter 312 provides a connection for hard disk drive 326, tape drive 328, and DVD/CD drive 330. Typical PCI local bus implementations will support three or four PCI expansion slots or add-in connectors.

An operating system runs on processor 302 and is used to coordinate and provide control of various components within data processing system 300 in FIG. 3. The operating system may be an open source operating system, such as Linux, or a Microsoft Windows® operating system or the like. Microsoft Windows® is a trademark of the Microsoft Corporation. An object oriented programming system, such as Java, may run in conjunction with the operating system and provide calls to the operating system from Java programs or applications executing on data processing system 300. Java is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary, depending on the implementation. Other internal hardware or peripheral devices, such as flash ROM (or an equivalent nonvolatile memory) or optical disk drives, USB drives and the like, may be used, in addition to or in place of, the hardware depicted in FIG. 3. Also, the processes of the present disclosure may be applied to a multiprocessor data processing system.

The depicted example in FIG. 3 and above-described examples are not meant to imply architectural limitations. For example, data processing system 300 may also be a mobile device such as a personal digital assistant (PDA) device, a cellular telephone, a tablet, a notebook, a laptop and other suitable types of devices. Data processing system 300 also may be a kiosk or a Web appliance.

Historically, job boards have not been able to effectively match job seekers to job postings. The largest job boards (i.e., Indeed, Monster) use unstructured data in matching candidates and posted jobs. Since unstructured data is used, candidates have not been properly matched to job postings. This has led to frustrated users (both job seekers and employers). Newer social platforms, such as LinkedIn, struggle also as peoples' profiles are inflated and not verified, and job posts and titles do not reflect real responsibility levels in organization and compensation data.

According to an embodiment of the invention, companies that are in the business of matching job seekers to employers (i.e., job matching companies, or employment services, or job boards etc.) may provide a forum or board (e.g., a job market board) to both job seekers and employers where both employers and job seekers may post messages. Messages from employers may be in the form of employer profiles, as well as job postings that may include compensation ranges. An employer profile may include a brief biography of the company and the company's business that may include different location(s) where the company may have a site, competitive compensation and benefits offers, work culture etc. By contrast, messages from job seekers may be in the form of profiles. A profile may include a resume, transcripts, certifications, and other documents that may be indicative of a skill set, education level, previous employments and salaries. Note that in this case, job seekers may be active (i.e., actively looking for employment) or passive (i.e., not currently looking for employment). Note also that employers, in this case, may include recruiters as well as hiring companies.

One particular aspect of the job market board, unlike LinkedIn etc., is that it is a non-social board (i.e., users do not have a public profile). This aspect of the job market board may allow job seekers to be more forthcoming in submitting their profiles since the profiles are not public.

Another aspect of the job market board is that a job seeker's employment history is not used to match the job seeker to job postings until a background search of the job seeker has been conducted to verify the job seeker's profile. This aspect of the job market board will assure that job seekers' profiles are not inflated and that previous or current compensation, title and responsibilities listed in a job seeker's employment history, for example, reflect real compensations, titles and responsibility levels in a previous or current organization. Updates of a job seeker's profile will also be verified. The background search may be paid for by the job seekers and may be conducted by the job matching company or by a third party (i.e., a background searching company) which may be approved by the job matching company.

A further aspect of the job market board is that a set of structured words (i.e., structured data) may be provided to both employers and job seekers. This aspect of the job market board will ensure that both employers and job seekers use the same structured words or data in posting their messages. The structured words or data may be centered around skills, experience, compensation, desired geographical locations or any structured words or data that the job matching company deems pertinent to accurately and effectively match job seekers to job postings. As mentioned earlier, the use of the structured words or data allows for better matching of job seekers to job postings.

The job matching company may also use psychometric and/or career assessment tests, as well as other data sources, to further enhance matching algorithms. A psychometric test is used to measure a person's suitability for a role based on required personality characteristics and aptitude or cognitive abilities. Thus, a psychometric test may identify the extent to which a person's personality and cognitive abilities match those required to perform a role. By contrast, a career assessment test can give a job seeker insight into the job seeker's career personality. That is, based on a characterization of the job seeker's personality, the job seeker may learn the type of work environments and occupations that best suit the job seeker. The result of a career assessment test, may provide a job seeker with a list of professions and/or occupations that best fit the job seeker's career personality.

Thus, the present invention provides an improvement over current methods of matching job seekers to job postings. That is, only users (i.e., recruiters/companies) that are serious about recruiting new talent will make use of the board, just as only users (i.e., job seekers) who are serious about obtaining a new job will frequent the board. Further, recruiters or companies will not have any more doubts about the veracity of information in a person's resume or profile since the profile will be verified. In addition, both the recruiters or companies and job seekers use the same structured words or data to make their submission which enables for a more accurate algorithm to be used to match job seekers to job postings.

Returning to FIG. 1, server 104 may represent a job matching company. Consequently, the job matching board (not shown) may be located on server 104. The job matching board may have a section available to job seekers and another section dedicated to employers or recruiters. While on the board, a job seeker has access only to information pertaining to the job seeker. In order for a job seeker at one of the client systems (i.e., clients 108, 110 or 112), for example, to access the section of the job matching board on server 104 that is dedicated to job seekers, the job seeker must present proper credentials to log onto that section of the job matching board. Once there, the job seeker may submit or update the job seeker's profile. As mentioned above, in submitting or updating the profile, the job seeker must use structured words or data that is provided by the job matching company. After submitting or updating the profile, the job seeker must authorize the use of a background search in order to verify the information on the profile. As mentioned before, until the background search has been conducted (i.e., until the profile is verified), the profile will not be used to match the job seeker to job postings that are on the job matching board.

In addition, the job matching company may suggest that the job seeker take a psychometric and/or a career assessment test. These tests may provide the job matching company with more data with which to accurately and effectively match the job seeker to the job postings.

Upon matching a job seeker to one or more job postings, the one or more job postings may be sent to the job seeker for review. If the job seeker is interested in one or more of the job postings, the job seeker may provide approval for the job matching company to send the job seeker's verified profile to one or all the employers that have a job posting in which the job seeker is interested. Until and unless the job seeker has done so, the job seeker's profile may not be sent to the employers. Note that results of psychometric tests and/or career assessment tests may not be sent to the employers and only verified profiles of job seekers may be sent to the employers.

Likewise, an employer at one of the client systems (i.e., clients 108, 110 or 112), for example, may access the section of the job matching board on server 104 that is dedicated to employers. As is the case of the job seekers, the employer must present proper credentials to log onto that section of the job matching board. Once there, the employer may submit or update an employer profile and submit or update job postings regarding available positions. As mentioned above, in submitting or updating a job posting or employer profile, the employer must use structured words or data that is provided by the job matching company. Further, the employer may only have access to information pertaining to the employer.

Once an employer has been sent a verified profile of a job seeker regarding a job posting submitted by the employer, the employer must indicate whether the employer is interested in pursuing the job seeker. Once that occurs, the job posting company may allow the employer to directly contact the job seeker. If the employer is not interested in pursuing the job seeker, the job matching company may notify the job seeker.

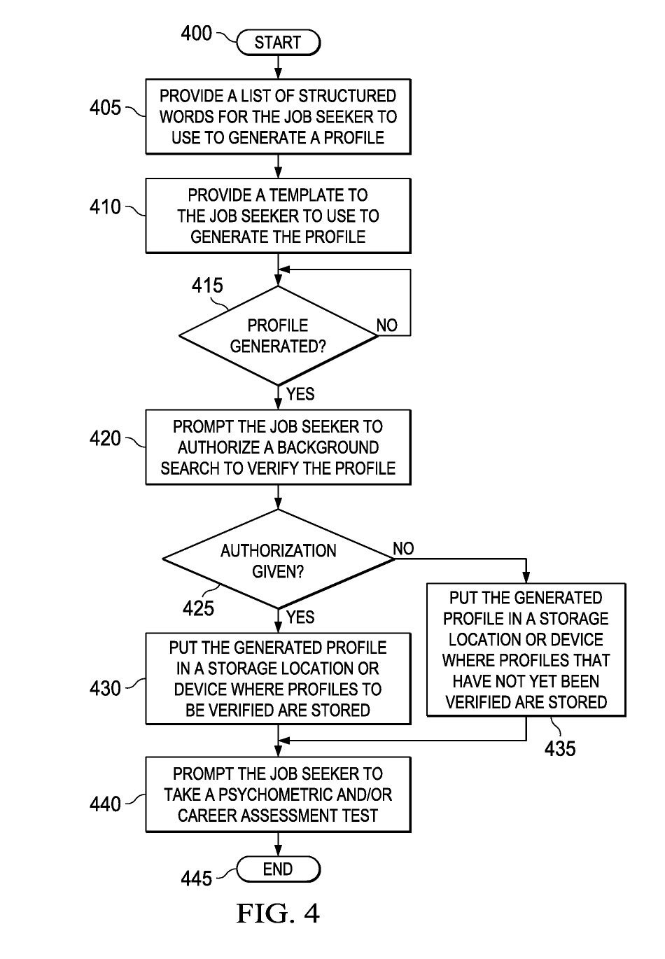

FIG. 4 depicts a flowchart of a process that may be used by a job seeker to submit a profile onto the job matching board in accordance with an illustrative embodiment. The process starts at block 400 when the job seeker logs onto the job seekers' section of the job posting board. While on that section, if the job seeker indicates that the job seeker needs to generate and submit and/or update a profile, a list of structured words (i.e., structured data) may be provided to the job seeker to use to generate a profile (block 405). Further, a template may be provided to the job seeker to use to generate the profile (block 410). The template is used to ensure that all job seekers use the same format, as well as to ensure the use of the structured words. A determination is made as to determine whether the profile is generated (block 415). If a profile has not been generated the process waits at block 415 until the profile has been generated. If a profile has been generated, the job seeker may be prompted to authorize a background search to verify the profile (block 420). A check will be done to determine whether authorization has been given for the background search (block 425). If so, the generated profile may be put in a storage location or device where profiles to be verified are stored (block 430). If the authorization is not given, the generated profile is put in a storage location or device where profiles that have not yet been given authorization to be verified are stored (block 435). After storing the generated profile, the job seeker may be prompted to take a psychometric and/or career assessment test (block 440). The process terminates thereafter when the job seeker exits from the job matching board (block 445).

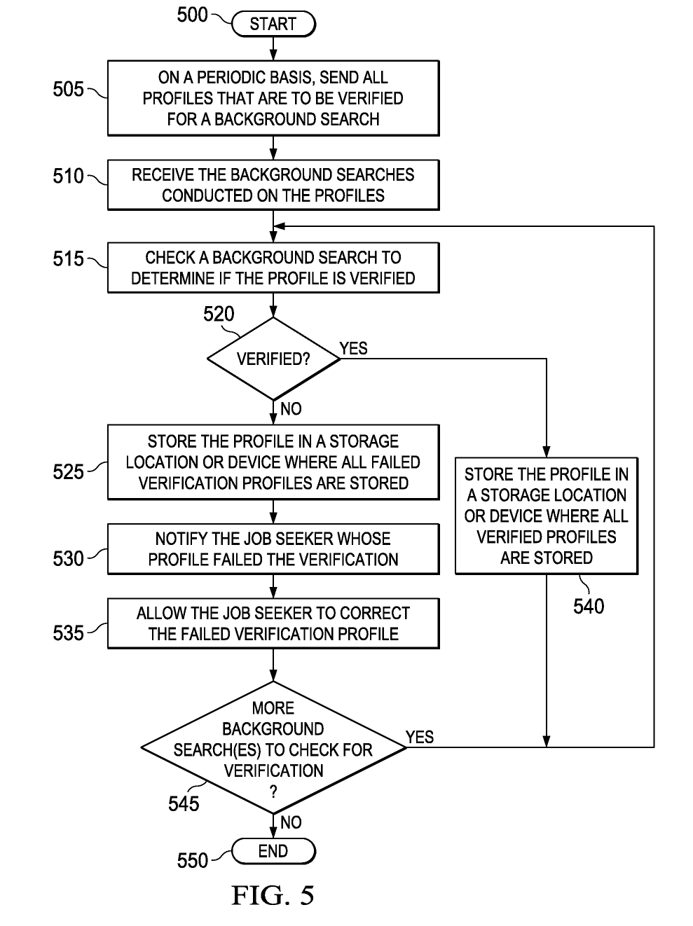

FIG. 5 depicts a flowchart of a process that may be used by a job matching company to ensure that profiles are verified in accordance with an illustrative embodiment. The process starts at block 500 where on a periodic basis the job matching company sends all profiles that are to be verified for a background search (block 505). The profiles may include profiles that are being verified for the first time, as well as profiles that have been corrected after having failed a previous verification. As mentioned before, the job matching company may conduct the verification itself or may have a third party do so. When the job matching company receives the background searches conducted on the profiles (block 510), the job matching company may check each background search to determine whether the profile on which the background search was conducted has been verified. To do so, the job matching company may check a (first) background search to determine whether the profile on which the background search was conducted is verified (blocks 515 and 520). If a profile is not verified, the job matching company may store the profile in a storage location or device where all failed verification profiles are stored (block 525). The process notifies the job seeker whose profile failed the verification (block 530) and allow the job seeker to correct the failed verification profile (block 535) with the process proceeding to block 545 thereafter. Returning to block 520, if a profile is verified, the job matching company may store the profile in a storage location or device where all verified profiles are stored (block 540). The process may then make a determination to see if more background checks need to be checked to determine if the profile on which the background searches were conducted have been verified (block 545). If so the process returns to block 515. If not the process terminates (block 550).

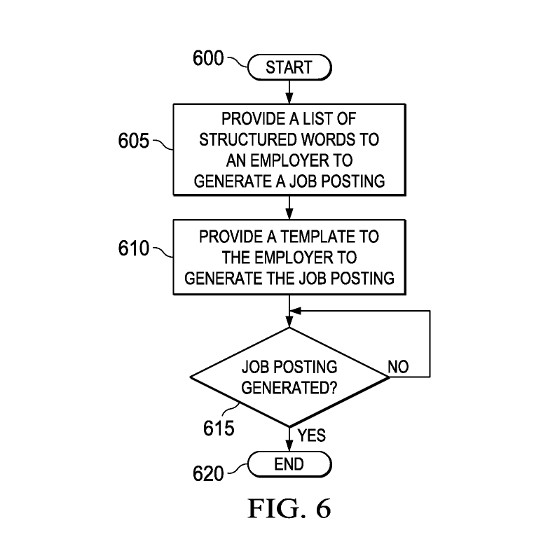

FIG. 6 depicts a flowchart of a process that may be used by an employer to submit job postings onto the job matching board in accordance with an illustrative embodiment. The process starts at block 600 when the employer logs onto the employers' section of the job posting board. While on that section, if the employer indicates that the employer needs to submit or update a job posting, a list of structured words may be provided to the employer to generate a job posting (block 605). This list includes the same structured words that are provided to job seekers when job seekers are to submit or update a profile. Further, a template may be provided to the employer to generate the job posting (block 610). The template is used to ensure that all employers use the same format as well as to ensure the use of the structured words. A check may be made to determine whether the job posting has been generated (block 615). If so, the process terminates thereafter (block 620). If not, the process waits at block 615 until the job posting is generated.

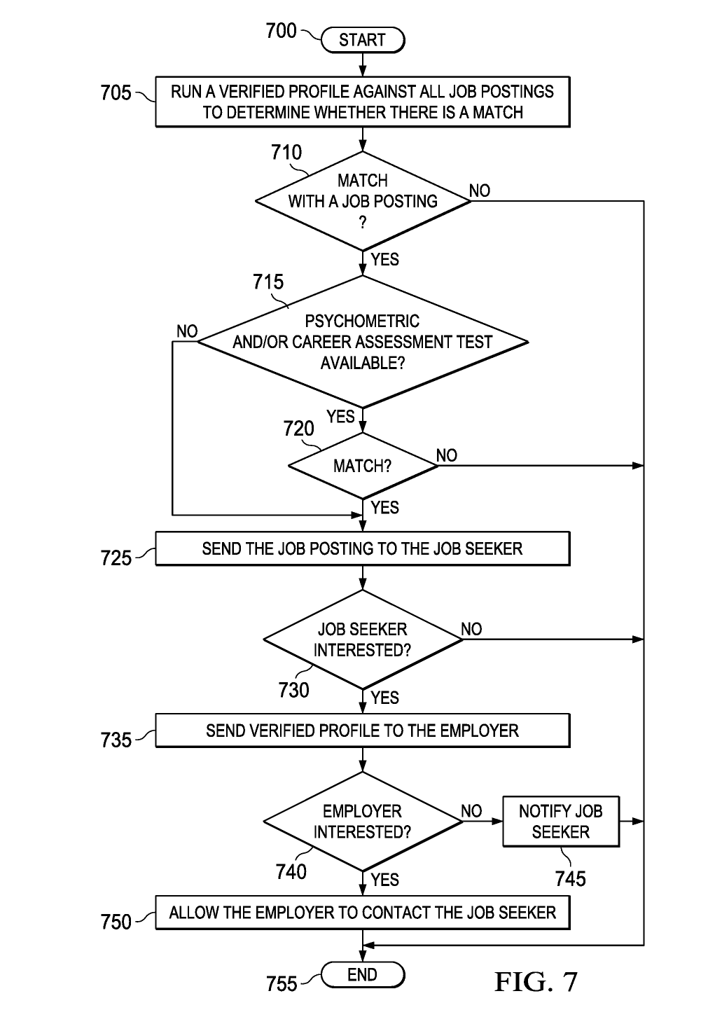

FIG. 7 depicts a flowchart of a process that may be used by a job matching company to match job seekers to job postings in accordance with an illustrative embodiment. The process starts at block 700 where on a periodic basis the job matching company runs a verified profile against all job postings to determine whether there is a match (block 705). In this case, the structured data or words in the profile are compared with the structured data or words in the job postings to see whether there is a match. A check is then made to determine whether there is a match with a job posting (block 710). If there is not a match, the process terminates (block 755). If there is match with a job posting, a check may be made to determine whether the job seeker had taken a psychometric and/or career assessment test (block 715). If not, the process proceeds to block 725. If the job seeker had taken a psychometric and/or career assessment test, then a check may be made to determine whether the psychometric and/or career assessment test indicates that the job seeker is a match for the job position in the job posting (block 720). Again, if there is not a match the process terminates (block 755). If, on the other hand there is a match, the job posting is sent to the job seeker (block 725). Upon receiving the job posting, the job seeker will have to indicate whether the job seeker is interested in the job posting. Thus, a check is made to determine if the job seeker is interested in the job posting (block 730). If not, the process terminates (block 755). If the job seeker is interested in the job posting, the verified profile of the job seeker is sent to the employer whose job posting is a match to the job seeker's profile (block 735). At this point in the process, the employer needs to indicate whether the employer is interested in the job seeker. Thus, a check is made to determine if the employer is interested in the job seeker (block 740). If not, the job seeker is notified (block 745) and the process terminates (block 755). If the employer is interested in the job seeker, the employer is allowed to directly contact the job seeker (block 750) with the process terminating thereafter (block 755).

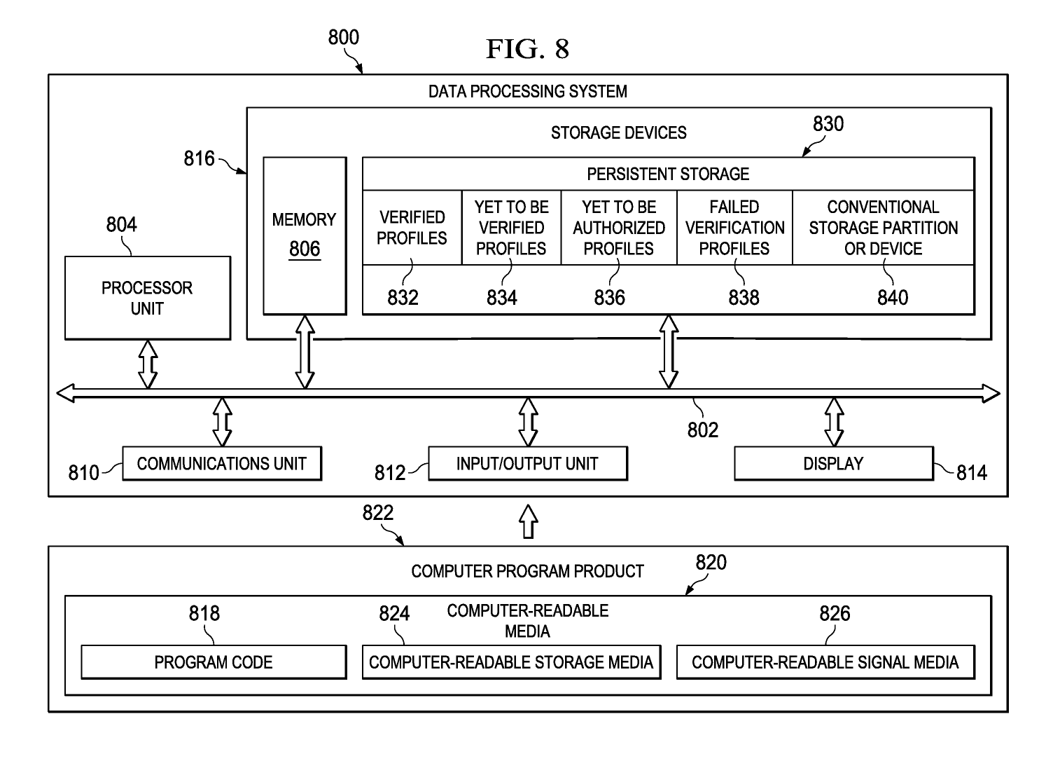

Turning now to FIG. 8, an illustration of a block diagram of a data processing system is depicted in accordance with an illustrative embodiment. Data processing system 800 represents a more specific implementation of server 104 in FIG. 1. In this illustrative example, data processing system 800 includes communications framework 802, which provides communications between processor unit 804, memory 806, persistent storage 830, communications unit 810, input/output unit 812, and display 814. In this example, communications framework 802 may take the form of a bus system.

Processor unit 804 serves to execute instructions for software that may be loaded into memory 806. Processor unit 804 may be a number of processors, a multi-processor core, or some other type of processor, depending on the particular implementation.

Memory 806 and persistent storage 830 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, may be, for example, a random access memory or any other suitable volatile or non-volatile storage device. Persistent storage 830 may take various forms, depending on the particular implementation.

For example, persistent storage 830 may contain one or more components, partitions or devices. In an illustrative embodiment, persistent storage 830 may be a hard drive, a flash memory, a rewritable optical disk, a rewritable magnetic tape, or some combination of the above. The media used by persistent storage 830 also may be removable. For example, a removable hard drive may be used for persistent storage 830.

In this particular implementation, persistent storage 830 is divided into five partitions or devices. The five partitions or devices include verified profiles 832, yet to be verified profiles 834, yet to be authorized profiles 836, failed verification profiles 838 and conventional storage partition or device 840. Verified profiles 832 may be used to store all verified profiles in accordance with block 540 of FIG. 5. Yet to be verified profiles 834 may be used to store all profiles for which a background verification has been authorized but not yet conducted as shown in block 430 of FIG. 4. Yet to be authorized profiles 836 may be used to store all profiles for which a background search has not yet been authorized as shown in block 435 of FIG. 4. Failed verification profiles 838 may be used to store all profiles that have not passed a background search in accordance with block 525 of FIG. 5. Conventional storage partition or device 840 may be used to store all other information that may be used by data processing system 800.

Communications unit 810, in these illustrative examples, provides for communications with other data processing systems or devices. In these illustrative examples, communications unit 810 is a network interface card.

Input/output unit 812 allows for input and output of data with other devices that may be connected to data processing system 800. For example, input/output unit 812 may provide a connection for user input through at least of a keyboard, a mouse, or some other suitable input device. Further, input/output unit 812 may send output to a printer.

Display 814 provides a mechanism to display information to a user. One type of information that may be displayed to a user is shown in FIG. 9 below.

Instructions for at least one of the operating system, applications, or programs may be located in storage devices 816, which are in communication with processor unit 804 through communications framework 802. The processes of the different embodiments may be performed by processor unit 804 using computer-implemented instructions, which may be located in a memory, such as memory 806.

These instructions are referred to as program code, computer usable program code, or computer readable program code that may be read and executed by a processor in processor unit 804. The program code in the different embodiments may be embodied on different physical or computer-readable storage media, such as memory 806 or persistent storage 830.

Program code 818 is located in a functional form on computer-readable media 820 that is selectively removable and may be loaded onto or transferred to data processing system 800 for execution by processor unit 804. Program code 818 and computer-readable media 820 form computer program product 822 in these illustrative examples. In one example, computer-readable media 820 may be computer-readable storage media 824 or computer-readable signal media 826.

In these illustrative examples, computer-readable storage media 824 is a physical or tangible storage device used to store program code 818 rather than a medium that propagates or transmits program code 818. Alternatively, program code 818 may be transferred to data processing system 800 using computer-readable signal media 826. Computer-readable signal media 826 may be, for example, a propagated data signal containing program code 818. For example, computer-readable signal media 826 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 800 are not meant to provide architectural limitations to the manner in which different embodiments may be implemented. The different illustrative embodiments may be implemented in a data processing system including components in addition to or in place of those illustrated for data processing system 800. Other components shown in FIG. 8 can be varied from the illustrative examples shown. The different embodiments may be implemented using any hardware device or system capable of running program code 818.

FIG. 9 depicts a list of structured words or data that may be displayed to a user in accordance with an illustrative embodiment. As mentioned above, the user may be a job seeker generating a profile on server 104 of FIG. 1 or a company and/or recruiter submitting a job posting. List 900 includes structured words or data such as skills 902, experience 904, compensation 906, education 908, geographical areas 910, and work culture 912. Note that list 900 may include more or less items. Thus, the items shown in list 900 are only for illustrative purposes.

In any event, in submitting a job posting, a recruiter or company may use structured words or data such as skills 902, experience 904, and education 908 to point to requirements of the position, as well as compensation 906 for indicating the compensation that the position commands. Geographical areas 910 indicate the location(s) where the position may be available and work culture 912 indicates the environment promoted by the company. Likewise, in submitting a profile, a job seeker may use structured words or data such as skills 902, experience 904, and education 908 to indicate the skills, experience and education, respectively, that the job seeker has. Further, the job seeker may use compensation 906 to indicate the salary, including benefits or other types of compensation that the job seeker may be willing to accept. Geographical areas 910 indicate the locations in the world in which the job seeker is willing to be relocated and work culture 912 is environment in which the job seeker prefers to work.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. For example, the sequence of the steps in FIGS. 4-7 may vary (i.e., box 410 may come before box 405 as shown in FIG. 4, or box 610 may come before box 605 as shown in FIG. 6). Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method of matching job seekers to job postings comprising:
providing a board in which job seekers and employers may post messages, wherein the messages from the employers include job postings, and wherein the messages from the job seekers include a profile;
defining a set of structured words to be used by both the job seekers and the employers in posting the messages; and
matching the job seekers to the job postings using the defined set of structured words.

2. The computer-implemented method of claim 1, wherein the profile includes a verified employment history.

3. The computer-implemented method of claim 2, wherein an employment history is verified through a background search.

4. The computer-implemented method of claim 3, wherein the profile further includes a psychometric test.

5. The computer-implemented method of claim 4, wherein the profile further includes an assessment test.

6. The computer-implemented method of claim 5, wherein employment histories may be updated.

7. The computer-implemented method of claim 6, wherein updated employment histories are also verified.

8. The computer-implemented method of claim 1, wherein the job postings include one of required skills, experiences and compensations.

9. The computer-implemented method of claim 8, wherein the job postings further include a description of a culture fostered by the employers, the culture being used to determine whether a fit exists between a job seeker and an employer.

10. A computing system for matching job seekers to job postings comprising:
at least one storage device to store program code; and
at least one processor for processing the program code to:
provide a board in which job seekers and employers may post messages, wherein the messages from the employers include job postings, and wherein the messages from the job seekers include a profile that is verified, the profile being verified by performing a background search that verifies information in the profile;
define a set of structured words to be used by both the job seekers and the employers in posting the messages; and
match the job seekers to the job postings using the defined set of structured words.

11. The computing system of claim 10, wherein employment histories may be updated and verified.

12. The computing system of claim 11, wherein the job postings further include a description of a culture fostered by the employers, the culture being used to determine whether a fit exists between a job seeker and an employer.

13. A computer program product for matching job seekers to job postings, the computer program product comprising:
a computer-readable storage medium having computer-readable program code embodied therewith for execution on a computing system, the computer-readable program code comprising computer-readable program code configured to:
provide a board in which job seekers and employers may post messages, wherein the messages from the employers include job postings, and wherein the messages from the job seekers include a profile;
define a set of structured words to be used by both the job seekers and the employers in posting the messages; and
match the job seekers to the job postings using the defined set of structured words.

14. The computer program product of claim 13, wherein the profile includes an employment history that is verified.

15. The computer program product of claim 14, wherein the employment history is verified through a background search.

16. The computer program product of claim 15, wherein the profile further includes a psychometric test.

17. The computer program product of claim 16, wherein the profile further includes an assessment test.

18. The computer program product of claim 17, wherein employment histories may be updated and verified.

19. The computer program product of claim 18, wherein the job postings include one of required skills, experiences, compensations, and desired geographical areas.

20. The computer program product of claim 19, wherein the job postings further include a description of a culture fostered by the employers, the culture being used to determine whether a fit exists between a job seeker and an employer.
